(19) United States
(12) Patent Application Publication
(10) Pub. No.: US 2018/0323911 A1
(43) Pub. Date: Nov. 8, 2018

(54) Device and Method of Handling a Code Block Group Retransmission

(71) Applicant: HTC Corporation, Taoyuan City (TW)

(72) Inventor: Ling-San Meng, Taoyuan City (TW)

(21) Appl. No.: 15/884,320

(22) Filed: Jan. 30, 2018

Related U.S. Application Data
(60) Provisional application No. 62/501,773, filed on May 5, 2017.

(51) Int. Cl. H04L 1/18; H04W 28/04

(52) U.S. Cl. CPC H04L 1/1829; H04W 28/04

(57) ABSTRACT

A communication device for handling a code block group (CBG) retransmission comprises a storage device and a processing circuit coupled to the storage device. The storage device stores, and the processing circuit is configured to execute instructions of: receiving at least one CBG of a transport block (TB) in a transmission from a network, wherein the at least one CBG comprises a plurality of code blocks (CBs); decoding the at least one CBG; generating at least one bit for indicating an unsuccessful decoding of a set of the at least one CBG, if the set of the at least one CBG is decoded unsuccessfully, wherein a size of the at least one bit and a number of CBGs of the at least one CBG are the same; transmitting a feedback message comprising the at least one bit to the network.

### CROSS REFERENCE TO RELATED APPLICATIONS

This application claims the benefit of U.S. Provisional Application No. 62/501,773 filed on May 5, 2017, which is incorporated herein by reference.

### BACKGROUND OF THE INVENTION

### 1. Field of the Invention

The present invention relates to a device and a method used in a wireless communication system, and more particularly, to a device and a method of handling a code block group retransmission.

### 2. Description of the Prior Art

In a long-term evolution (LTE) system, a radio access network known as an evolved universal terrestrial radio access network (E-UTRAN) includes at least one evolved Node-B (eNB) for communicating with a user equipment (UE), and for communicating with a core network. The core network may include a mobility management and a Quality of Service (QoS) control for the UE.

### SUMMARY OF THE INVENTION

The present invention therefore provides a communication device and method for handling a code block group (CBG) retransmission to solve the abovementioned problem.

A communication device for handling a code block group (CBG) retransmission comprises a storage device and a processing circuit coupled to the storage device. The storage device stores, and the processing circuit is configured to execute instructions of: receiving at least one first CBG of a transport block (TB) in a first transmission from a network, wherein the at least one first CBG comprises a first plurality of code blocks (CBs); decoding the at least one first CBG; generating at least one first bit for indicating an unsuccessful decoding of a set of the at least one first CBG, if the set of the at least one first CBG is decoded unsuccessfully, wherein a size of the at least one first bit and a number of CBGs of the at least one first CBG are the same; transmitting a first feedback message comprising the at least one first bit to the network; receiving at least one second CBG of the TB in a second transmission from the network in response to the first feedback message, wherein the at least one second CBG comprises a second plurality of CBs; decoding the at least one second CBG; generating at least one second bit for indicating an unsuccessful decoding of a set of the at least one second CBG, if the set of the at least one second CBG is decoded unsuccessfully, wherein a size of the at least one second bit and a number of CBGs of the at least one second CBG are the same; and transmitting a second feedback message comprising the at least one second bit to the network.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication system according to an example of the present invention.

FIG. 2 is a schematic diagram of a communication device according to an example of the present invention.

FIG. 3A and FIG. 3B are flowcharts of a process according to an example of the present invention.

### DETAILED DESCRIPTION

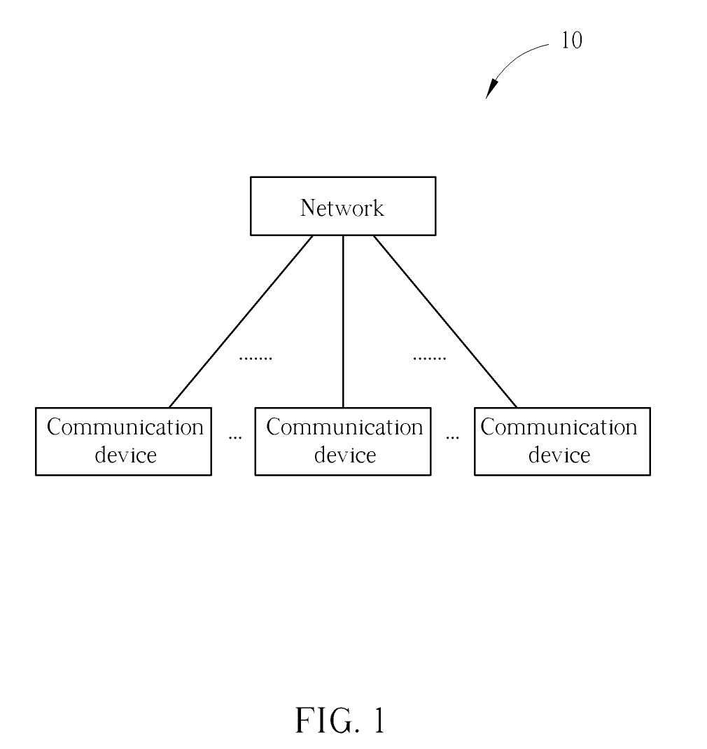

FIG. 1 is a schematic diagram of a wireless communication system 10 according to an example of the present invention. The wireless communication system 10 is briefly composed of a network and a plurality of communication devices. The network and a communication device communicate with each other via one or more cells on one or more carriers of licensed band(s) and/or unlicensed band(s). The one or more cells may be operated in the same or different frame structure types, or in the same or different duplexing modes, i.e. frequency-division duplexing (FDD) and time-division duplexing (TDD).

In FIG. 1, the network and the communication devices are simply utilized for illustrating the structure of the wireless communication system 10. The network may include a radio access network (RAN) including at least one base station (BS). Practically, the RAN may be an evolved universal terrestrial radio access network (E-UTRAN) including at least one evolved Node-B (eNB). The RAN may be a fifth generation (5G) network including at least one 5G BS (e.g. , gNB) which employs orthogonal frequency-division multiplexing (OFDM) and/or non-OFDM and a transmission time interval (TTI) shorter than 1 ms (e.g. 100 or 200 microseconds), to communicate with the communication devices. In general, a BS may also be used to refer any of the eNB and the 5G BS. Furthermore, the network may also include a core network which includes network entities connecting to the RAN.

A communication device may be a user equipment (UE), a narrowband Internet of Things (NB-IoT) UE, a machine type communication (MTC) device, a mobile phone, a laptop, a tablet computer, an electronic book, a portable computer system, a vehicle, or an aircraft. In addition, the network and the communication device can be seen as a transmitter or a receiver according to direction (i.e., transmission direction), e.g., for an uplink (UL), the communication device is the transmitter and the network is the receiver, and for a downlink (DL), the network is the transmitter and the communication device is the receiver.

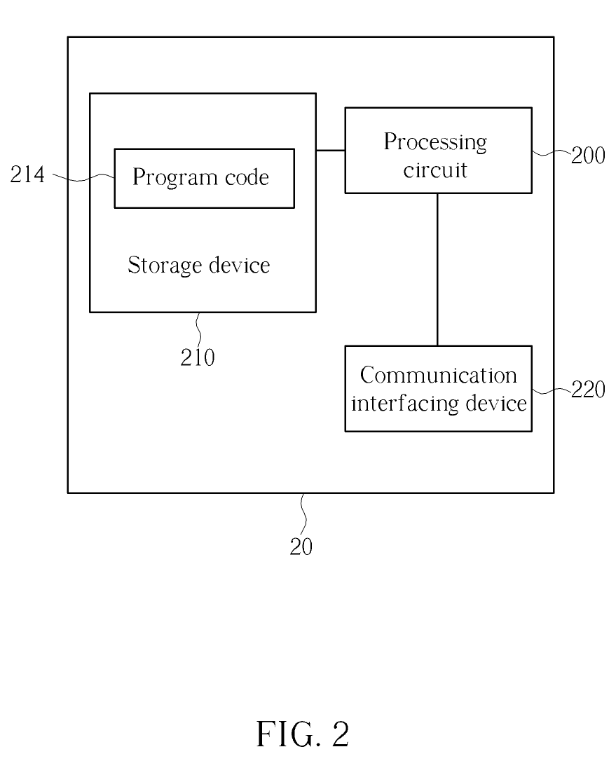

FIG. 2 is a schematic diagram of a communication device 20 according to an example of the present invention. The communication device 20 may be a communication device or the network shown in FIG. 1, but is not limited herein. The communication device 20 may include a processing circuit 200 such as a microprocessor or Application Specific Integrated Circuit (ASIC), a storage device 210 and a communication interfacing device 220. The storage device 210 may be any data storage device that may store a program code 214, accessed and executed by the processing circuit 200. Examples of the storage device 210 include but are not limited to a subscriber identity module (SIM), read-only memory (ROM), flash memory, random-access memory (RAM), hard disk, optical data storage device, non-volatile storage device, non-transitory computer-readable medium (e.g., tangible media), etc. The communication interfacing device 220 includes a transceiver and is used to transmit and receive signals (e.g., data, messages and/or packets) according to processing results of the processing circuit 200.

In the following embodiments, a UE is used to represent a communication device in FIG. 1, to simplify the illustration of the embodiments.

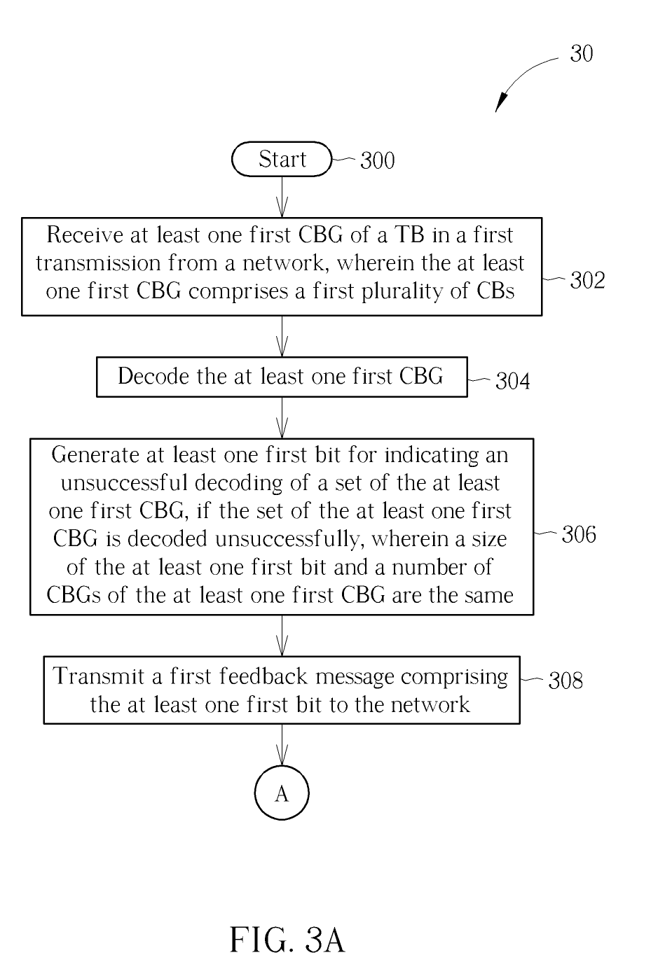

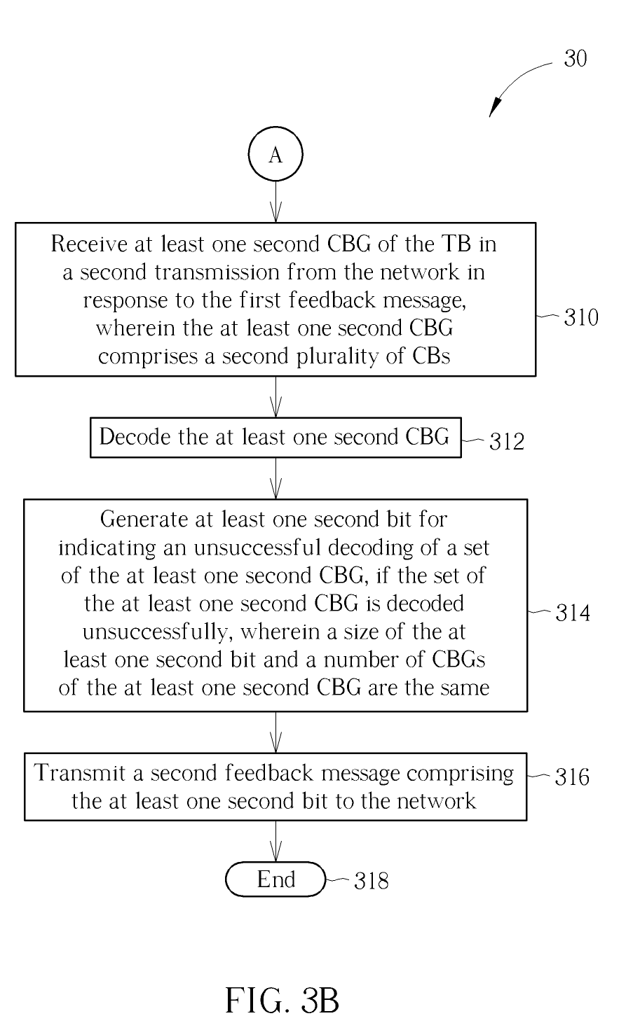

FIG. 3A and FIG. 3B are flowcharts of a process 30 according to an example of the present invention. The process 30 may be utilized in a UE, to transmit data. The process 30 includes the following steps:

Step 300: Start.

Step 302: Receive at least one first code bloc group (CBG) of a transport block (TB) in a first transmission from a network, wherein the at least one first CBG comprises a first plurality of code blocks (CBs).

Step 304: Decode the at least one first CBG.

Step 306: Generate at least one first bit for indicating an unsuccessful decoding of a set of the at least one first CBG, if the set of the at least one first CBG is decoded unsuccessfully, wherein a size of the at least one first bit and a number of CBGs of the at least one first CBG are the same.

Step 308: Transmit a first feedback message comprising the at least one first bit to the network.

Step 310: Receive at least one second CBG of the TB in a second transmission from the network in response to the first feedback message, wherein the at least one second CBG comprises a second plurality of CBs.

Step 312: Decode the at least one second CBG.

Step 314: Generate at least one second bit for indicating an unsuccessful decoding of a set of the at least one second CBG, if the set of the at least one second CBG is decoded unsuccessfully, wherein a size of the at least one second bit and a number of CBGs of the at least one second CBG are the same.

Step 316: Transmit a second feedback message comprising the at least one second bit to the network.

Step 318: End.

According to the process 30, the UE receives at least one first CBG of a TB in a first transmission from a network, wherein the at least one first CBG comprises a first plurality of CBs. The UE decodes the at least one first CBG. The UE generates at least one first bit for indicating an unsuccessful decoding of a set of the at least one first CBG, if the set of the at least one first CBG is decoded unsuccessfully, wherein a size of the at least one first bit and a number of CBGs of the at least one first CBG are the same. Then, the UE transmits a first feedback message comprising the at least one first bit to the network. The UE receives at least one second CBG of the TB in a second transmission from the network in response to the first feedback message, wherein the at least one second CBG comprises a second plurality of CBs. The UE decodes the at least one second CBG. The UE generates at least one second bit for indicating an unsuccessful decoding of a set of the at least one second CBG, if the set of the at least one second CBG is decoded unsuccessfully, wherein a size of the at least one second bit and a number of CBGs of the at least one second CBG are the same. Then, the UE transmits a second feedback message comprising the at least one second bit to the network.

That is, the number of bits for indicating a next (re)transmission and the number of CBGs decoded in the current (re)transmission are the same. For example, 5 bits for indicating a first decoding result that 3 CBGs are decoded unsuccessfully are fed back to the network, if the UE receives 5 CBGs in the first transmission. Then, 3 bits for indicating a second decoding result are fed back to the network, after the UE receives 3 retransmitted CBGs in the second transmission. Thus, not only ambiguity of retransmission of CBGs is solved, but overhead for performing the retransmission is reduced.

Realization of the process 30 is not limited to the above description. The following examples may be applied to the process 30.

In one example, the UE determines the set of the at least one first CBG is decoded unsuccessfully, if each of the set of the at least one first CBG exists a CB decoded unsuccessfully. Similarly, the UE determines the set of the at least one second CBG is decoded unsuccessfully, if each of the set of the at least one second CBG exists a CB decoded unsuccessfully.

In one example, the UE receives a first DL control information (DCI), and receives the at least one first CBG according to the first DCI. In one example, the first DCI comprises a first CBG indication field for scheduling the at least one first CBG, and the UE identifies the at least one first CBG according to the first CBG indication field and a CBG configuration. Similarly, the UE receives a second DCI, and receives the at least one second CBG according to the second DCI. In one example, the second DCI comprises a second CBG indication field for scheduling the at least one second CBG, and the UE identifies the at least one second CBG according to the second CBG indication field and a CBG configuration. Not that the same CBG configuration may be applied to the at least one first CBG and the at least one second CBG, and is not limited herein.

In one example, the size of the at least one second bit is not greater (or smaller) than the size of the at least one first bit. That is, the number of bits for indicating a retransmission can be reduced gradually in successive retransmissions.

In one example, the UE decodes the at least one first CBG, if a CBG indication field for scheduling the at least one second CBG is consistent with the first feedback message. In one example, the UE generates at least one third bit for indicating a successful decoding of the at least one second CBG, if a CBG indication field for scheduling the at least one second CBG is not consistent with the first feedback message, wherein a size of the at least one third bit and the number of CBGs of the at least one second CBG are the same. Then, the UE transmits a third feedback message comprising the at least one third bit to the network. That is, the UE abandons the retransmission, if understandings of retransmitted CBGs are not the same for the UE and the network. The processing of the retransmission of the TB is passed to a higher layer.

In one example, the UE identifies the at least one second CBG according to a CBG configuration (e.g., the same as that applied to the at least one first CBG and the at least one second CBG) and a TB size (TBS) of DL data of the TB. In one example, the first transmission is an initial transmission or a retransmission. In one example, the second transmission is a retransmission. In one example, the UE generates at least one fourth bit for indicating a successful decoding of the at least one second CBG, if the at least one second CBG is decoded successfully, wherein a size of the at least one fourth bit and the number of CBGs of the at least one second CBG are the same. Then, the UE transmits a fourth feedback message comprising the at least one fourth bit to the network.

An example of initial transmission and retransmissions is detailed as follows.

ABS generates a first DCI for a UE, and generates an associated first DL data for the UE. The first DCI includes at least on of resource allocation (RA) information and a modulation coding scheme (MCS) of the first DL data. The first DCI may further include a first CBG indication field for indicating CBGs that are scheduled to be transmitted. The BS transmits the first DCI and the associated first DL data to the UE.

After the UE receives the first DCI, the UE obtains a TBS of the first DL data implicitly by a predetermined relationship between the TBS, the RA information, and the MCS, e.g., via a lookup table. In another example, the first DCI may explicitly include a field indicating the TBS. The UE determines a number of CBs in the first DL data by using a CB size which may be a fixed (e.g., standardized constant) and the TBS. For example, assuming the specification recites that a CB corresponds to 8000 information bits and that the TBS is 80000 bits, the UE can determine that the number of CBs is 80000/8000=10 CBs.

In one example, the UE determines that a number of CBGs is the same as a length of the CBG indication field. In one example, the UE determines that a length of the first CBG indication field by using at least a CBG configuration which is signaled via a radio resource control (RRC) layer. In one example, a length of the first CBG indication field in the first DCI is the same as the CBG configuration. If the CBG configuration via the RRC layer is 5, the BS determines that the length of the first CBG indication field is 5 bits. In one example, the length of the first CBG indication field may be defined in a 3GPP specification.

In one example, the UE determines the number of CBGs by using both the CBG configuration and the TBS of the first DL data. The UE determines that the number of CBGs is the same as the CBG configuration, if the TBS is greater than a predetermined threshold. Otherwise, the UE determines the number of CBGs based on the TBS according to a predetermined relationship, e.g., recited in a specification. For example, it can be recited in the specification that if the TBS is smaller than 80000 bits, the UE determines that the number of CBGs is 1, i.e., only one group. Otherwise, the UE determines that the number of CBGs is the same as the CBG configuration. In one example, the predetermined threshold can be expressed in units of CBs.

In one example, the UE determines the number of CBGs by using at least the CBG configuration. How the number of CBGs is determined is known to both the UE and the BS, e.g., recited in a specification. The UE may determine a CB grouping by using at least one of the number of CBs and the number of CBGs.

The UE utilizes the first DCI to receive and decode the first DL data. The UE decodes all CB in the first DL data. The UE determines decoding results for all CBGs. A decoding result for a particular CBG is an acknowledgement (ACK), if all of the CBs in the CBG are decoded successfully. Otherwise, the decoding result is a negative ACK (NACK). The UE generates a first HARQ feedback message comprising the decoding results of all the CBGs in the first DL data. A length of the first HARQ feedback message is the same as the number of CBGs, i.e., there is a one-to-one mapping between the HARQ feedback message and the CBGs. Then, the UE transmits the first HARQ feedback message to the BS via a UL physical channel, e.g., new radio—physical UL control channel (NR-PUCCH).

The BS receives the first HARQ feedback message from the UE. The BS generates a second DL data based on the first HARQ feedback message by including CBGs indicated as NACK. The BS also generates a second DCI associated with the second DL data.

The second DCI includes a second CBG indication field. A length of the second CBG indication field is the same the first CBG indication field. The BS indicates which CBGs are retransmitted in the second DL data by using the second CBG indication field. In one example, the BS sets content of the second CBG indication field to be the same as the first HARQ message. NACK(s) in the second CBG indication field may indicate that the corresponding CBGs are retransmitted in the second DL data. In one example, the BS sets content of the second CBG indication field to be the first HARQ message with bits therein toggled. ACK(s) in the second CBG indication field may indicate the corresponding CBGs are retransmitted. A CBG is retransmitted means that all CBs belonging to the CBG are retransmitted. Then, the BS transmits the second DCI and the second DL data to the UE.

After the UE receives the second DCI, the UE obtains the second CBG indication field in the second DCI. If content of the second CBG indication is logically consistent with the first HARQ feedback message, i.e., CBGs indicated as NACKs in the first HARQ feedback message matches CBGs indicated as being retransmitted in the second CBG indication field, the UE proceeds to receive and decode the second DL data by using the second DCI.

In one example, the UE generates a second HARQ feedback message corresponding to decoding results of retransmitted CBGs. The UE indicates all CBGs that have been indicated as ACK previously as ACK in the second HARQ message. A length of the second HARQ feedback message is the same as the length of the first HARQ feedback message. The UE transmits the second HARQ feedback message to the BS.

In another example, the UE generates a second HARQ feedback message corresponding to decoding results of the retransmitted CBGs. A length of the second HARQ feedback message is the same as a number of the retransmitted CBGs as indicated in the second CBG indication field, i.e., feedback corresponding to the CBGs that are not retransmitted in the second DL data are not included in the second HARQ feedback message. Then, the UE transmits the second HARQ feedback message to the BS via the UL physical channel.

After the BS receives the second HARQ feedback message from the UE, at least one CBG determined (e.g., decoded, read or detected) as NACK(s) in the first HARQ feedback message may be determined as ACK(s) in the second HARQ feedback message. The BS continues to generate a third DL data by including all the CBGs indicated as NACK in the second HARQ feedback message. The BS generates a third DCI corresponding to the third DL data. The BS configures a third CBG indication field in the third DCI according to the above description. Then, the BS transmits the third DCI and the third DL data to the UE.

In an example where the UE transmits the second HARQ feedback message only for those CBGs that are retransmitted in the second DL data, the BS receives the second HARQ feedback message with an understanding that only the decoding results for the retransmitted CBGs in the second DL data are included in the second HARQ feedback message. In one example, if the UE finds that at least one CBG indicated as NACK(s) in a HARQ feedback message is not indicated as being retransmitted in a following CBG indication field, i.e., a NACK-to-ACK error has occurred, the UE transmits a HARQ feedback message with ACKs for all the retransmitted CBGs to the BS.

In all of the above examples, if the BS receives a HARQ feedback messages indicating ACKs for all the CBGs, the BS stops performing a retransmission.

Those skilled in the art should readily make combinations, modifications and/or alterations on the abovementioned description and examples. For example, the skilled person easily makes new embodiments of the network based on the embodiments and examples of the UE, and makes new embodiments of the UE based on the embodiments and examples of the network. The abovementioned description, steps and/or processes including suggested steps can be realized by means that could be hardware, software, firmware (known as a combination of a hardware device and computer instructions and data that reside as read-only software on the hardware device), an electronic system, or combination thereof. An example of the means may be the communication device 20. Any of the above processes and examples above may be compiled into the program code 214.

To sum up, the present invention provides a method and a communication device for handling retransmission of CBGs. Not only ambiguity of retransmission of CBGs is solved, but overhead for performing the retransmission is reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication device for handling a code block group (CBG) retransmission, comprising:
a storage device; and
a processing circuit, coupled to the storage device, wherein the storage device stores, and the processing circuit is configured to execute instructions of:
receiving at least one first CBG of a transport block (TB) in a first transmission from a network, wherein the at least one first CBG comprises a first plurality of code blocks (CBs);
decoding the at least one first CBG;
generating at least one first bit for indicating an unsuccessful decoding of a set of the at least one first CBG, if the set of the at least one first CBG is decoded unsuccessfully, wherein a size of the at least one first bit and a number of CBGs of the at least one first CBG are the same;
transmitting a first feedback message comprising the at least one first bit to the network;
receiving at least one second CBG of the TB in a second transmission from the network in response to the first feedback message, wherein the at least one second CBG comprises a second plurality of CBs;
decoding the at least one second CBG;
generating at least one second bit for indicating an unsuccessful decoding of a set of the at least one second CBG, if the set of the at least one second CBG is decoded unsuccessfully, wherein a size of the at least one second bit and a number of CBGs of the at least one second CBG are the same; and
transmitting a second feedback message comprising the at least one second bit to the network.

2. The communication device of claim 1, wherein the communication device determines that the set of the at least one first CBG is decoded unsuccessfully, if each of the set of the at least one first CBG exists a CB decoded unsuccessfully.

3. The communication device of claim 1, wherein the instructions further comprise:
receiving a first downlink (DL) control information (DCI); and
receiving the at least one first CBG according to the first DCI.

4. The communication device of claim 3, wherein the first DCI comprises a first CBG indication field for scheduling the at least one first CBG, and the instructions further comprise:
identifying the at least one first CBG according to the first CBG indication field and a CBG configuration.

5. The communication device of claim 1, wherein the instructions further comprise:
receiving a second DCI; and
receiving the at least one second CBG according to the second DCI.

6. The communication device of claim 5, wherein the second DCI comprises a second CBG indication field for scheduling the at least one second CBG, and the instruction further comprises:
identifying the at least one second CBG according to the second CBG indication field and a CBG configuration.

7. The communication device of claim 1, wherein the size of the at least one second bit is not greater than the size of the at least one first bit.

8. The communication device of claim 1, wherein the communication device decodes the at least one second CBG, if a CBG indication field for scheduling the at least one second CBG is consistent with the first feedback message.

9. The communication device of claim 1, wherein the instructions further comprise:
generating at least one third bit for indicating a successful decoding of the at least one second CBG, if a CBG indication field for scheduling the at least one second CBG is not consistent with the first feedback message, wherein a size of the at least one third bit and the number of CBGs of the at least one second CBG are the same; and
transmitting a third feedback message comprising the at least one third bit to the network.

10. The communication device of claim 1, wherein the instructions further comprise:
identifying the at least one second CBG according to a CBG configuration and a TB size (TBS) of DL data of the TB.

11. The communication device of claim 1, wherein the first transmission is an initial transmission or a retransmission.

12. The communication device of claim 1, wherein the second transmission is a retransmission.

13. The communication device of claim 1, wherein the instructions further comprise:
generating at least one fourth bit for indicating a successful decoding of the at least one second CBG, if the at least one second CBG is decoded successfully, wherein a size of the at least one fourth bit and the number of CBGs of the at least one second CBG are the same; and
transmitting a fourth feedback message comprising the at least one fourth bit to the network.
